(19) United States
(12) Patent Application Publication
(10) Pub. No.: US 2026/0155269 A1
(43) Pub. Date: Jun. 4, 2026

(54) METHOD OF TESTING LEAK RATE OF REACTOR CONTAINMENT BUILDING

(71) Applicant: KOREA HYDRO & NUCLEAR POWER CO., LTD, Gyeongju-si (KR)

(72) Inventors: Che Wung HA, Daejeon (KR); Jeong Kwan SUH, Daejeon (KR); Sun Guk Kwon, Daejeon (KR)

(21) Appl. No.: 18/716,698

(22) PCT Filed: Nov. 29, 2023
(86) PCT No.: PCT/KR2023/019394

§ 371 Date: Jun. 5, 2024

(30) Foreign Application Priority Data
Mar. 7, 2023 (KR) 10-2023-0029733

(51) Int. Cl. G21C 17/00; G01M 3/26

(52) U.S. Cl. CPC G21C 17/002; G01M 3/26

(57) ABSTRACT

Disclosed is a method of testing a leak rate of a reactor containment building, the method including: a division step of dividing the reactor containment building into an upper containment area and a lower containment area by a spectacle flange; a measurement step of measuring the leak rate of the containment building after pressurizing the inside of the containment building at a maximum pressure; and an identification step of identifying whether the leak rate measured in the measurement step satisfies an allowable standard for the leak rate of the containment building.

### TECHNICAL FIELD

The disclosure relates to a method of testing a leak rate of a reactor containment building.

### BACKGROUND ART

An integrated leak rate test for a containment building is to ensure the airtightness of the containment building and confirm the public safety by proving that a leak rate of the containment building is within an allowable range for 24 hours on the assumption that a design basis accident (DBA) occurs in the containment building.

Conventionally, to measure the leak rate of the containment building in the nuclear power plant, increase or decrease in the pressure of the containment building is calculated based on change in the volume of the containment building while maintaining the flow rate of instrument air supplied to the inside of the containment building for a certain period of time, thereby measuring the leak rate per hour.

Further, the leakage test is performed by draining a large amount of radioactive fluid completely and pressing air, and thus a large amount of radioactive liquid waste is generated, thereby requiring high costs to dispose of the waste.

Because the large amount of radioactive fluid is drained before the leakage test, a replenishment process is additionally required after the leakage test, thereby causing a problem of unnecessarily spending a lot of time on the test.

In this case, a problem arises even in operation, as an operator and a mechanic are exposed to a lot of radiation upon the drainage and replenishment of the fluid.

### DISCLOSURE

### Technical Problem

An aspect of the disclosure is to provide a method of testing a leak rate of a reactor containment building.

### Technical Solution

The aspect of the disclosure is achieved by a method of testing a leak rate of a reactor containment building, the method including: a division step of dividing the reactor containment building into an upper containment area and a lower containment area by a spectacle flange; a measurement step of measuring the leak rate of the containment building after pressurizing the inside of the containment building at a maximum pressure; and an identification step of identifying whether the leak rate measured in the measurement step satisfies an allowable standard for the leak rate of the containment building.

The measurement step may include: a first measurement step of measuring a first leak rate of the lower containment area after pressurizing the lower containment area at a first maximum pressure; and a first measurement step of measuring a second leak rate of the upper containment area after pressurizing the upper containment area at a second maximum pressure lower than the first maximum pressure.

The first maximum pressure and the second maximum pressure may be set to 80% to 100% of the maximum pressure in a design basis accident of the reactor containment building.

The identification step may include: a first identification step of identifying whether the first leak rate satisfies an allowable standard for the leak rate of the lower containment area; and a second identification step of identifying whether the second leak rate satisfies an allowable standard for the leak rate of the upper containment area.

The identification step may further include a third identification step of comparing a sum of the first and second leak rates with a sum of the allowable standards for the leak rates of the upper and lower containment areas to identify whether an allowable standard for a leak rate is satisfied.

The method may further include: a depressurization step of depressurizing the containment building at the atmospheric pressure after the measurement step; and a restoration step of releasing the spectacle flange after performing the depressurization step.

The depressurization step may include: a first depressurization step of depressurizing the lower containment area at the atmospheric pressure after the first measurement step; and a second depressurization step of depressurizing the upper containment area at the atmospheric pressure after the second measurement step.

The lower containment area may include an in-containment refueling water storage tank, and the upper containment area may include a radioactive-material removal tank.

The spectacle flange may be placed
in a radioactive material transport line that connects the in-containment refueling water storage tank and the radioactive-material removal tank.

### Advantageous Effects

According to the disclosure, there is provided a method of testing a leak rate of a reactor containment building.

### DESCRIPTION OF DRAWINGS

FIG. 1 is a flowchart showing a method of testing a leak rate of a reactor containment building according to a first embodiment of the disclosure,

FIG. 2 illustrates an upper containment area and a lower containment area of a reactor containment building in the testing method according to the first embodiment of the disclosure,

FIG. 3 is a detailed flowchart showing a measurement step, a depressurization step, and an identification step in the method of testing a leak rate of a reactor containment building according to the first embodiment of the disclosure,

FIG. 4 is a detailed flowchart showing a measurement step, a depressurization step, and an identification step in a method of testing a leak rate of a reactor containment building according to a second embodiment of the disclosure, and

FIG. 5 is a flowchart showing a method of testing a leak rate of a reactor containment building according to a third embodiment of the disclosure.

### MODE FOR INVENTION

Below, the disclosure will be described in more detail with reference to the accompanying drawings. The accompanying drawings are merely an example illustrated to describe the technical concept of the disclosure in more detail, and thus the technical concept of the disclosure is not limited to the accompanying drawings.

Below, a system-integrated modular advanced reactor (SMART) 100 will be described as an example, but a reactor/a containment building to which the disclosure is applied is not limited thereto.

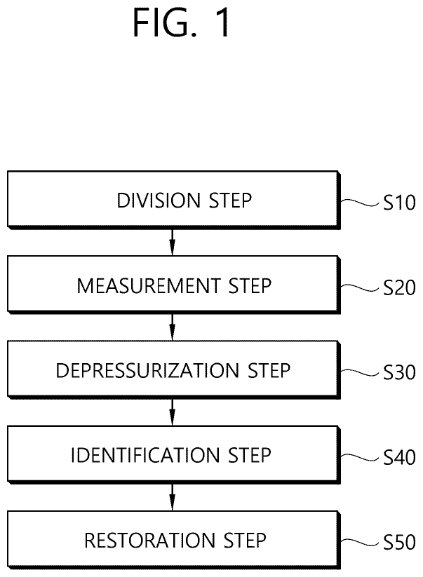

A method of testing a leak rate of a reactor containment building will be described with reference to FIGS. 1 to 3.

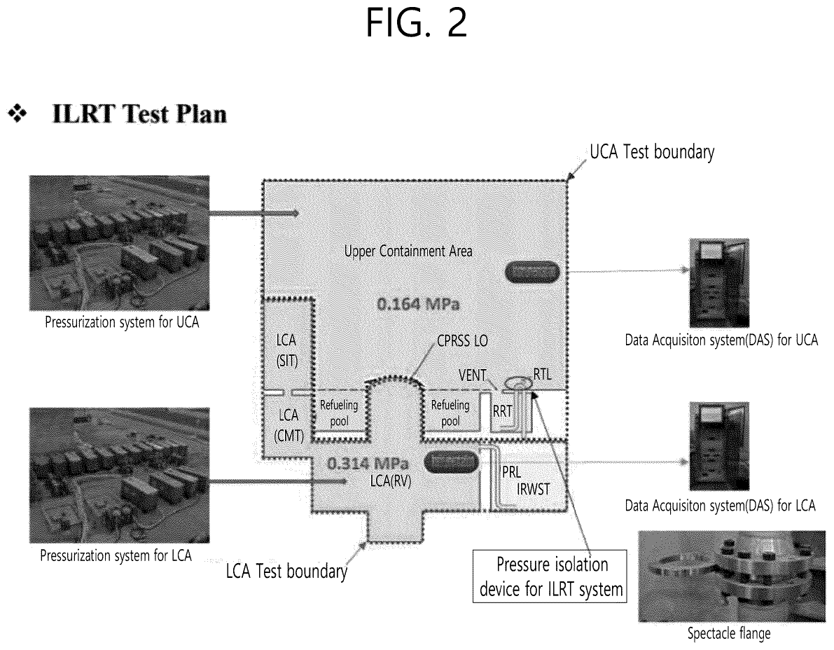

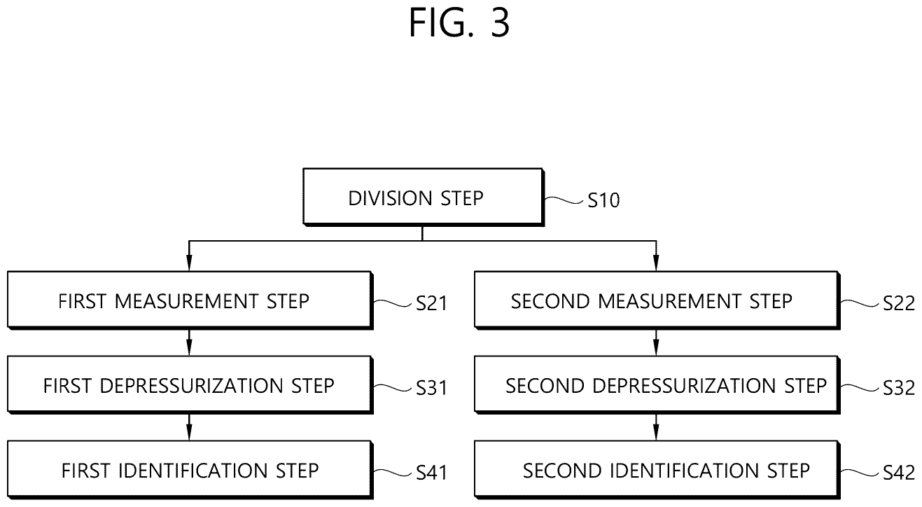

FIG. 1 is a flowchart showing a method of testing a leak rate of a reactor containment building according to a first embodiment of the disclosure, FIG. 2 illustrates an upper containment area and a lower containment area of a reactor containment building in the testing method according to the first embodiment of the disclosure, and FIG. 3 is a detailed flowchart showing a measurement step, a depressurization step, and an identification step in the method of testing a leak rate of a reactor containment building according to the first embodiment of the disclosure.

The method of testing a leak rate of a reactor containment building according to this embodiment includes a division step S10, a measurement step S20, a depressurization step S30, an identification step S40, and a restoration step S50.

The identification step S40 is performed after or before the depressurization step S30. According to an alternative embodiment, the identification step S40 may be performed after the restoration step S50.

In the division step S10, a spectacle flange is used to divide the reactor containment building into an upper containment area and a lower containment area.

The spectacle flange is located in a radioactive material transport line (RTL) that connects an in-containment refueling water storage tank (IRWST) and a radioactive-material removal tank (RRT).

As shown in FIG. 2, the upper containment area (UCA) includes the RRT, an upper pressurization system, and an upper data acquisition system (DAS).

The lower containment area (LCA) includes the IRWST, a lower pressurization system, and a lower data acquisition system (DAS).

In the measurement step S20, the inside of the containment building is pressurized at the maximum pressure, and the leak rate of the containment building is then measured.

Here, the maximum pressure refers to the maximum pressure Pa calculated under the assumption that a design basis accident (DBA) in the containment building occurs.

In the case of the containment building of the SMART 100, the upper containment area and the lower containment area are divided by water, and a pressure difference occurs between the upper containment area and the lower containment area due to a hydraulic head difference between the RRT and the IRWST.

For example, on the assumption that the design basis accident (DBA) occurs in the containment building, the maximum pressure of the upper containment area is 0.1642 MPa (23.81 psi), and the maximum pressure in the lower containment area is 0.3142 MPa (45.57 psi). That is, the maximum pressure of the upper containment area and the maximum pressure of the lower containment area are different from each other.

The measurement step S20 includes a first measurement step S21 and a second measurement step S22.

In the first measurement step S21, the lower containment area is pressurized at the first maximum pressure, and a first leak rate in the lower containment area is then measured.

The first maximum pressure is set based on the maximum pressure Pa of the lower containment area on the assumption that the design basis accident (DBA) occurs in the containment building.

For example, the first maximum pressure may be 0.25 MPa to 0.32 MPa, 0.28 MPa to 0.32 MPa, or 0.3140 MPa to 0.3142 MPa.

In the second measurement step S22, the upper containment area is pressurized at the second maximum pressure, and a second leak rate in the upper containment area is then measured.

The second maximum pressure is set based on the maximum pressure Pa of the upper containment area on the assumption that the design basis accident (DBA) occurs in the containment building.

For example, the second maximum pressure may be 0.13 MPa to 0.17 MPa, 0.16 MPa to 0.17 MPa, or 0.1640 MPa to 0.1642 MPa.

The second maximum pressure is lower than the first maximum pressure, and the first maximum pressure and the second maximum pressure may be set to 80% to 100%, or 90% to 100% of the maximum pressure in the design basis accident of the reactor containment building.

Details of the measurement step S20 will be described below with reference to FIG. 3.

In the first embodiment shown in FIG. 3, the first measurement step S21 and the second measurement step S22 are performed simultaneously.

However, according to an alternative embodiment, the first measurement step S21 may be performed before the second measurement step S22, or the second measurement step S22 may be performed before the first measurement step S21.

In the depressurization step S30, the pressure of air pressurized in the measurement step S20 is depressurized to the atmospheric pressure.

The depressurization step S30 includes a first depressurization step S31 and a second depressurization step S32.

As shown in FIG. 3, the first depressurization step S31 is performed to depressurize the lower containment area to the atmospheric pressure after the first measurement step S21, and the second depressurization step S32 is performed to depressurize the upper containment area to the atmospheric pressure after the second measurement step S22.

According to an alternative embodiment, the first depressurization step S31 may be performed first, the second depressurization step S32 may be performed first, or the first depressurization step S31 and the second depressurization step S32 may be performed simultaneously.

In the identification step S40, it is identified whether the leak rate measured in the measurement step S20 satisfies the allowable leak rate standard for the containment building.

The identification step S40 includes a first identification step S41, a second identification step S42 and a third identification step S43.

In the first embodiment shown in FIG. 3, the first identification step S41 and the second identification step S42 are performed after the first depressurization step S31 and the second depressurization step S32.

In the first identification step S41, it is identified whether the first leak rate satisfies the standard for an allowable leak rate La[LCA] of the lower containment area.

The allowable leak rate La refers to a value specified in operation guidelines as the leak rate limit of the reactor containment building at a reference test pressure.

When the first leak rate is within a certain level with respect to the standard for the allowable leak rate of the lower containment area, it is identified that the lower containment area satisfies the standard for the allowable leak rate. On the other hand, when the first leak rate exceeds the certain level, an operator is warned of leakage from the lower containment area.

The certain level may be selected within, for example, 70% to 80% of the allowable leak rate.

However, the certain level is not limited the foregoing example. According to an alternative embodiment, the certain level may be selected within 0.74 La[LCA] to 0.76 La[LCA].

In the second identification step S42, it is identified whether the second leak rate satisfies the standard for the allowable leak rate La[UCA] of the upper containment area.

When the second leak rate is within a certain level with respect to the standard for the allowable leak rate of the upper containment area, it is identified that the upper containment area satisfies the standard for the allowable leak rate. On the other hand, when the second leak rate exceeds the certain level, an operator is warned of leakage from the upper containment area.

Here, the certain level may be selected within, for example, 70% to 80% of the allowable leak rate.

According to an alternative embodiment, the certain level may be selected within 0.74 La[UCA] to 0.76 La[UCA].

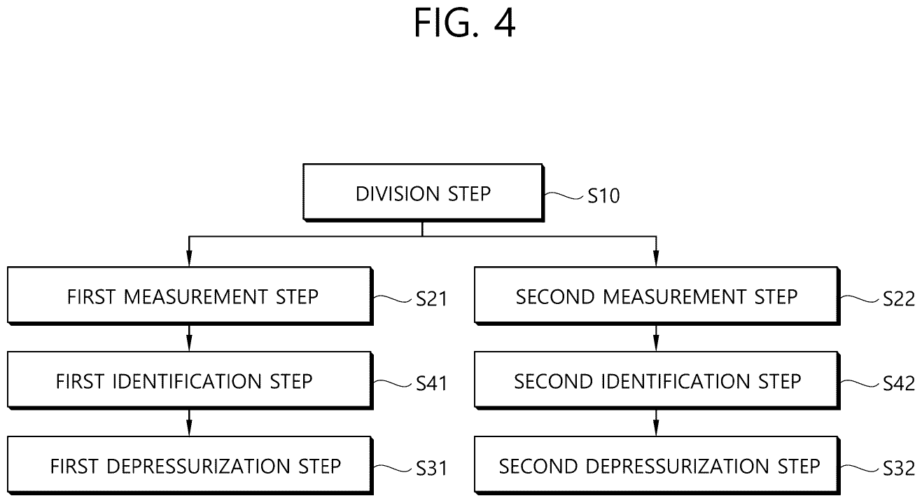

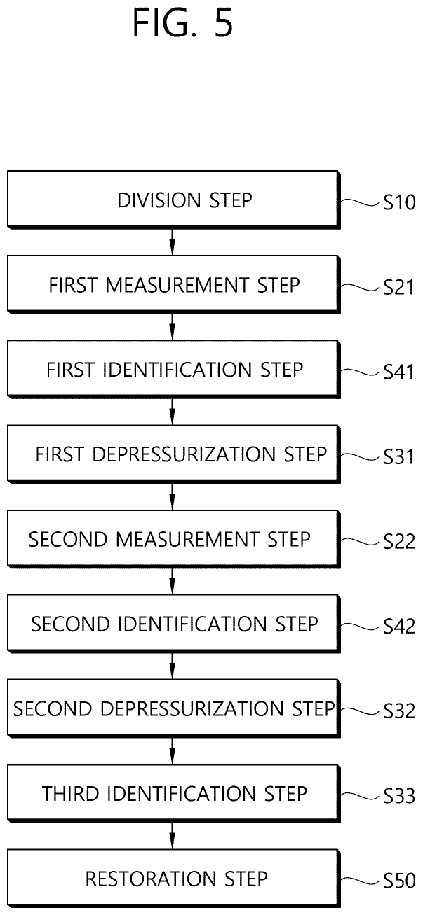

Below, second and third embodiments will be described with reference to FIGS. 4 and 5.

FIG. 4 is a detailed flowchart showing a measurement step, a depressurization step, and an identification step in a method of testing a leak rate of a reactor containment building according to a second embodiment of the disclosure, and FIG. 5 is a flowchart showing a method of testing a leak rate of a reactor containment building according to a third embodiment of the disclosure.

In the second embodiment shown in FIG. 4, the first identification step S41 and the second identification step S42 are performed before the first depressurization step S31 and the second depressurization step S32.

In the third identification step S43, the sum of the first and second leak rates is compared with the sum of the allowable leak rate standards of the upper and lower containment areas (La[UCA+LCA]) to identify whether the sum satisfies the allowable leak rate standard.

When the sum of the first and second leak rates is within a certain level compared to the allowable leak rate standards for the upper and lower containment areas, it is identified that the sum satisfies the allowable leak rate standards for the entire containment building. On the other hand, when the sum exceeds the certain level, an operator is warned of the leakage from the containment building.

Here, the certain level may also be selected within 70% to 80% of the allowable leak rate.

According to an alternative embodiment, the certain level may be selected within 0.74 La[UCA+LCA] to 0.76 La[UCA+LCA].

The third identification step S43 will be described in detail with reference to FIG. 5 along with the depressurization step S30 (to be described later).

In the restoration step S50, the spectacle flange is released to restore the pressure of the containment building and a containment pressure and radioactivity suppression system (CPRSS) to their original states.

The restoration step S50 is performed after the depressurization step S30.

In the third embodiment shown in FIG. 5, the restoration step S50 is performed last after all the steps, and the third identification step S43 is performed before the restoration step S50.

Although not shown, according to an alternative embodiment, the identification step S40 including the third identification step S43 may be performed after the restoration step S50.

Further, according to the third embodiment, the method of measuring the leakage rate in the lower containment area is performed including the first identification step S41, the first measurement step S21, the first identification step S41, and the first depressurization step S31, and then the method of measuring the leakage rate in the upper containment area is performed including the second measurement step S22, the second identification step S42, and the second depressurization step S32.

However, according to still another embodiment, the method of measuring the leakage rate in the upper containment area may be performed before the method of measuring the leakage rate in the lower containment area.

According to the disclosure, a conservative integrated leak rate test for the containment building of the SMART100 is possible without additional design changes, thereby economically reducing additional costs, and making it possible to gain the standard design approval because licensing requirements are satisfied.

Further, when individual containment areas are tested, more conservative results in terms of the leak rate may be obtained because other adjacent containment areas are maintained at pressure (atmospheric pressure) lower than the pressure of an actual accident.

By the method according to the disclosure, in particular, in the case of the SMART100, the integrated leak rate test of the reactor containment building may be performed by injecting air only into the lower containment area (LCA) through an air compressor.

According to the method of the disclosure, it is possible to measure the amount of air leaking from the LCA to the UCA due to the pressure difference between the UCA and the LCA.

Further, it is also possible to measure the amount of air leaking from the LCA or UCA to the outside through the building.

Although a few embodiments of the disclosure have been described above in detail, it is apparent to a person having ordinary knowledge in the art that such embodiments are merely exemplary embodiments and do not limit the scope of the disclosure. Therefore, the substantial scope of the disclosure is defined by appended claims and their equivalents.

1. A method of testing a leak rate of a reactor containment building, the method comprising:
a division step of dividing the reactor containment building into an upper containment area and a lower containment area by a spectacle flange;
a measurement step of measuring the leak rate of the containment building after pressurizing the inside of the containment building at a maximum pressure; and
an identification step of identifying whether the leak rate measured in the measurement step satisfies an allowable standard for the leak rate of the containment building.

2. The method of claim 1, wherein the measurement step comprises:
a first measurement step of measuring a first leak rate of the lower containment area after pressurizing the lower containment area at a first maximum pressure; and
a first measurement step of measuring a second leak rate of the upper containment area after pressurizing the upper containment area at a second maximum pressure lower than the first maximum pressure.

3. The method of claim 2, wherein the first maximum pressure and the second maximum pressure are set to 80% to 100% of the maximum pressure in a design basis accident of the reactor containment building.

4. The method of claim 2, wherein the identification step comprises:
a first identification step of identifying whether the first leak rate satisfies an allowable standard for the leak rate of the lower containment area; and
a second identification step of identifying whether the second leak rate satisfies an allowable standard for the leak rate of the upper containment area.

5. The method of claim 4, wherein the identification step further comprises a third identification step of comparing a sum of the first and second leak rates with a sum of the allowable standards for the leak rates of the upper and lower containment areas to identify whether an allowable standard for a leak rate is satisfied.

6. The method of claim 2, further comprising:
a depressurization step of depressurizing the containment building at the atmospheric pressure after the measurement step; and
a restoration step of releasing the spectacle flange after performing the depressurization step.

7. The method of claim 6, wherein the depressurization step comprises:
a first depressurization step of depressurizing the lower containment area at the atmospheric pressure after the first measurement step; and
a second depressurization step of depressurizing the upper containment area at the atmospheric pressure after the second measurement step.

8. The method of claim 1, wherein
the lower containment area comprises an in-containment refueling water storage tank, and
the upper containment area comprises a radioactive-material removal tank.

9. The method of claim 8, wherein the spectacle flange is placed in a radioactive material transport line that connects the in-containment refueling water storage tank and the radioactive-material removal tank.
